(19) United States
(12) Patent Application Publication
(10) Pub. No.: US 2009/0082230 A1
(43) Pub. Date: Mar. 26, 2009

(54) Well Treatment Fluids Containing Nanoparticles and Methods of Using Same

(75) Inventors: Paul H. Javora, Spring, TX (US); Qi Qu, Spring, TX (US)

Correspondence Address: John Wilson Jones;Jones & Smith, LLP, Ste. 800, 2777 Allen Pkwy, Houston, TX, 77019-2129, US

(73) Assignee: BJ Services Company

(21) Appl. No.: 11/859,606

(22) Filed: Sep. 21, 2007

(51) Int. Cl. C09K 8/60

(52) U.S. Cl. 507/269

(57) ABSTRACT

An aqueous-based well treatment fluid containing an additive having a median particle size less than 1 micron is suitable for use in a wide variety of well treatment applications including use as a drill-in fluid, thermal insulating fluid, spacer or fluid loss control additive. The fluid may consist of a high density brine. The additive is capable of viscosifying the water or brine. Viscosification of the water or brine may occur in the substantial absence of a polymeric viscosifying agent.

### FIELD OF THE INVENTION

A well treatment fluid containing an additive having a median particle size less than 1 micron may be used as a drill-in fluid, thermal insulating fluid, spacer or fluid loss control additive as well as in other well treatment applications.

### BACKGROUND OF THE INVENTION

Well treatment fluids are used to exploit oil and gas from subterranean petroliferous formations. Exemplary of such fluids are drill-in fluids. Drill-in fluids are pumped through the drill pipe during the drilling of the producing, or payzone, area or the injection zone of the formation. The drill-in fluid deposits a low-permeable filter cake on the walls of the wellbore which thereby seals that portion of the permeable formation which is exposed by the drilling bit. The filter cake further limits loss of fluid from the wellbore during cementing operations.

Further exemplary of well treatment fluids are completion fluids and workover fluids. Completion and workover fluids commonly are used in conjunction with a fluid loss control additive or fluid loss pill when control of fluid loss is required. The fluid loss pill prevents or inhibits fluid loss to the formation and typically contains one or more bridging agents to augment fluid loss control. A filter cake is thus deposited directly against the formation and may even become embedded in the formation.

Drill-in fluids, completion fluids and workover fluids are typically brine-based. The density range of suitable brines is wide. For instance, brines used in drill-in fluids are often greater than 12 pounds per gallon (ppg). Suitable brines for well treatment fluids include sodium chloride, sodium bromide, calcium chloride, calcium bromide, zinc bromide, sodium formate, potassium formate, cesium formate and mixtures thereof.

Well treatment fluids further typically contain a viscosifying agent (or primary suspending agent) for thickening of the base fluid. Requisite viscosity and/or gel structure is therefore provided by the viscosifying agent. The viscosifying agent further keeps suspensoids of the well treatment fluid from settling. In drill-in fluids, it is the viscosifying agent which increases the ability of the fluid to suspend and/or flush rock and other particulate matter out of the wellbore. With completion and workover fluids, the viscosifying polymer, added to a small potion of the fluid, functions as a fluid loss pill such that fluid loss is alleviated by the relatively high viscosity that is generated along with any solid material that would be added to deposit onto the formation. Drill-in fluids further function by deposition of a filter cake onto the formation.

The need for well treatment fluids to exhibit the requisite viscosity for keeping suspensoids from settling has often limited applications of well treatment fluids to defined temperatures. For instance, the maximum temperature for the use of calcium halide based brines is typically no greater than 250° F. and the maximum temperature for the use of sodium halide based brines is typically no greater than 300° F. When temperatures are above these limits, suspensoids settle from the well treatment fluid as viscosity and solids' carrying capacity of the fluid is lost.

Since brine-based drill-in fluids, completion fluids and workover fluids often must be capable of withstanding high temperatures, alternative methods for keeping suspensoids from settling from the brine at high temperatures have been sought. Maintaining the suspensoids within the brine is necessary in order for the fluid to remain uniform and be readily pumpable. Alternatives are especially needed for applications requiring temperatures in excess of 250° F.

### SUMMARY OF THE INVENTION

A well treatment fluid defined herein contains an additive which has a median particle size of less than 1 micron. The well treatment fluid is aqueous-based and may contain brine as well as water. Especially suitable are high density brines, such as those having a density greater than about 9 pounds per gallon (ppg). Non-aqueous based fluids may also be used for this invention.

The mean particle size of the additive is less than or equal to 0.5 microns and typically is less than or equal to 0.1 microns. The additive is capable of viscosifying the water or brine. As such, viscosification of the water or brine occurs in the substantial absence of a polymeric viscosifying agent as well as a secondary suspending agent or fluid loss control agent.

The well treatment fluid is stable at temperatures up to 350° F. or more. The fluid typically exhibits greater thermal stability than a water or brine-based well treatment fluid containing the like additive with a median particle size greater than or equal to 3 microns.

The well treatment fluid is especially suitable as a drill-in fluid as well as a completion or workover fluid or fluid loss control additive, such as a fluid loss pill. In a preferred embodiment, the completion or workover fluid is a thermal insulating fluid or a spacer.

The well treatment fluid, which may be introduced into a wellbore or subterranean formation, has particular applicability in the formation of a filter cake deposited from a drilling fluid, drill-in fluid and/or fluid loss pill containing drilled and/or added solids.

### DETAILED DESCRIPTION OF THE PREFERRED EMBODIMENTS

The well treatment fluid defined herein contains nanoparticles used as viscosifying agent. The nanoparticles typically have a median particle size of less than 1 micron. In a preferred embodiment, the mean particle size of the nanoparticles is less than or equal to 0.5 microns and more preferably less than or equal to 0.1 microns.

The aqueous based fluid for the well treatment fluid can be water, seawater or brine. In addition, a non-aqueous based fluid may further be used. Suitable non-aqueous based fluids include oils, solvents, glycols and polyglycols.

For instance, the non-aqueous based fluid may be selected from a variety of polyols. Preferably the polyols are selected from the group consisting of glycerol, glycols, polyglycols and mixtures thereof. The glycols include commonly known glycols such as ethylene glycol, propylene glycol and butylene glycol.

The polyglycols can be selected from a wide range of known polymeric polyols that include polyethylene glycol, poly(1,3-propanediol), poly(1,2-propanediol), poly(1,2-butanediol), poly(1,3-butanediol), poly(1,4-butanediol), poly(2,3-butanediol), co-polymers, block polymers and mixtures of these polymers. Most commercially available polyglycols include polyethylene glycol, and are usually designated by a number that roughly corresponds to the average molecular weight. Examples of useful commercially available polyethylene glycols include polyethylene glycol 600, polyethylene glycol 1000, polyethylene glycol 1500, polyethylene glycol 4000 and polyethylene glycol 6000.

Suitable oils include linear paraffins (alkanes), isoparaffins, terpenes, diesel, mineral oil, synthetic or organic oils and olefins (especially linear olefins). Suitable organic oils include soybean oil and corn oil. Suitable oils include from which monoterpenes, sesquiterpenes, diterpenes, triterpenes and tetraterpenes are extracted, such as citrus oil, pine or pinus oil, hemp oil, needle oil, tea tree oil, etc. Derivatives of terpenes, such as turpentines (including blends of natural terpenes and synthetic terpenes, dipentines and/or allocimenes (building blocks of terpene resins) and pyrodenes (breakdown products of terpenes) are also suitable. Preferred terpenes include carotene, d-limonene, pinene, farnesene, camphor, cymene and menthol. Biodegradable monoterpenes, such as d-limonene and alpha-pinene are also preferred.

The non-aqueous solvent may be one or more solvents selected from hydrocarbons and/or halogenated hydrocarbon (such as aliphatic hydrocarbons and aromatic hydrocarbons), fatty acids, glycol ethers, ethers and/or alcohols. Examples of suitable alcohols include linear, branched and cyclic C₁ to C₂₀ alcohols, such as a linear or branched C₄ to C₂₀ alcohols.

The nanoparticles may be oil soluble, water soluble, acid soluble and/or base soluble and are preferably inorganic materials or organometallic materials. Suitable acid soluble materials include inorganic materials such as calcium carbonate. Suitable water soluble materials include inorganic materials such as calcium chloride, sodium chloride, potassium chloride, sodium bromide, potassium bromide and calcium bromide and organometallic compounds such as sodium formate, potassium formate, sodium acetate and potassium acetate. Suitable base soluble materials include benzoic acid and boric acid. Suitable oil soluble materials include waxes and resins.

The nanoparticles used in the well treatment fluid are capable of being suspended in the fluid without the aid of a polymeric viscosifying agent. Thus, they are referred to as “self-suspended” particles because they are capable of being suspended in the well treatment fluid without the aid (or in the substantial absence) of a viscosifying polymer. Thus, unlike well treatment fluids of the prior art, the well treatment fluids defined herein do not require a polymeric viscosifying agent to thicken the water and/or brine.

In some instances, it may be desired to make some minor adjustments to the composition of the brine in order for the nanoparticles to remain completely dispersed in the brine. In those instances, the brine is treated with a secondary agent, such as a dispersing agent.

While the aqueous fluid of the well treatment fluid may be just water (such as fresh water or salt water), it is more typically a brine. Normally, the well treatment fluid contains between from about 20 to about 99 weight percent water or brine.

The brine used in the well treatment fluid may be a lighter brine, such as those having a density of less than 11 ppg, or a heavy brine (including those having a density of 18 ppg or higher). Typically, the density of the brine is greater than about 9 ppg and more typically greater than or equal to 13 ppg.

The brine may be saturated or unsaturated brine. By saturated brine, it is understood that the brine is saturated with at least one salt. This includes potassium acetate brine, potassium bromide brine, potassium chloride brine, potassium formate brine, sodium acetate brine, sodium chloride brine, sodium formate brine, sodium bromide brine, calcium chloride brine, calcium bromide brine, zinc bromide brine, cesium acetate brine, cesium bromide brine, cesium chloride brine, cesium formate brine and mixtures thereof.

The amount of nanoparticles introduced into the water or brine is dependent upon the composition and density of the brine, and typically requires between from about 1 to about 150, preferably between from about 60 to about 110 pounds per barrel (ppb).

Well treatment fluids containing the defined nanoparticles are more thermally stable than well treatment fluids of the prior art employing similar materials of greater mean particle size, such as calcium carbonate, which are required to be suspended in a polymeric viscosifying agent.

The well treatment fluid defined herein may be stable at a temperature of 350° F. or higher and in some instances may be stable at a temperature of 400° F. or higher.

While exhibiting improved thermal stability, the well treatment fluid of the invention possesses the requisite viscosity for its intended use and further evidences minimal, if any, sag. Sag typically results from the inability of a well treatment fluid, under particular well conditions, to provide adequate suspension properties. The result is a settling of suspensoids contained in the well treatment fluid. Reduced or no sag is seen in the well treatment fluids defined herein. For instance, nanoparticles suspended in a well treatment fluid, even at temperatures as high as 350° F., typically exhibit sag no greater than about 8% (without the need of a viscosifying agent), and preferred fluids containing a dispersing agent exhibit essentially no sag.

Improved rheology at very high temperatures and undesired sag may further be minimized by the addition of rheological clays, such as (pre-hydrated) bentonite or (sheared) attapulgite clay, to aid suspension. Generally, however, such clays are not desired when the intended use of the well treatment fluid is as a fluid loss pill since such clays may cause formation damage. Sag may further be minimized by adding lime or additional amounts of nano-particulate calcium carbonate (in 10 pound per barrel (ppb) increments) to the well treatment fluids. The amount of lime added to the well treatment fluids, when it is desired to reduce sag, is generally between from about 0.2 to about 4.0 ppb.

The well treatment fluid may further contain one or more conventional well treatment additives such as corrosion inhibitors, paraffin inhibitors, asphaltene dispersants, biocides, pH regulating substances, viscosifying polymers, fluid loss control agents or polymers, scale inhibitors, sized fluid loss materials, etc. For instance, an alkaline material, such as lime, calcium oxide, magnesium hydroxide, magnesium oxide, sodium hydroxide, potassium carbonate and sodium carbonate, may be a component of the well treatment fluid in order to maintain the alkalinity of the treating fluid and/or to counter acidic gases which are often evidenced during well treatment operations. Further, the pH of the well treatment fluid may need to be adjusted with an acid. Typical acids are fumaric, hydrochloric, acetic and citric. Generally, buffering of the well treatment fluid at a higher pH may increase the thermal stability of the fluid, especially when conventional additives are incorporated.

The well treatment agent may further contain a suspension stabilizer or insulation fluid additive, such as derivatized HEC, xanthan gum, carboxymethylhydroxypropyl guar (CMHPG), carboxymethylcellulose (CMC), guar gum, cellulose, sodium alginate, and water soluble or dispersible synthetic polymers such as derivatized poly- acrylate and -acrylamide. Typically, these additives are unnecessary because the nanoparticles do not settle from the fluid. When however they are employed, the amount present in the well treatment fluid is typically between from about 0.2 to about 4 ppb.

In a preferred embodiment, the well treatment fluid containing the nanoparticles is introduced into the wellbore or formation as a drill-in fluid, a thermal insulating fluid, a spacer or a fluid loss control pill.

When employed as a thermal insulating fluid, the fluid may be prepared on the surface and then pumped through tubing in the wellbore or in the annulus. In a preferred embodiment, the well treatment fluid is a packer or riser fluid and the packer fluid is introduced above the packer in an annulus and the riser fluid is introduced into a riser annulus.

Such thermal insulating fluids serve a dual purpose. First, the fluid serves to prevent heat transfer/buildup in the outer annuli. Second, it serves to retain heat within the produced hydrocarbons. The thermal insulating fluid may be added either into an annulus or riser in order to effectively reduce undesired heat loss from production tubing, or heat transfer to outer annuli. The fluid is capable of securing the insulation of the wellbore while reducing the amount of heat transfer from the production tubing to the surrounding wellbore, internal annuli, and riser. The fluid further is formulated to provide high viscosity at low shear rate so as to reduce the rate of fluid convection to near zero.

When used as a thermal insulating composition, the density of the fluid will typically be dictated by the required hydrostatic pressure needed to control the well, and the amount and type of salt dissolved within the composition (resulting from the brine, etc.).

The well treatment fluid may further be used in other wellbore applications, such as displacement and cement spacers. Spacers are typically used because of incompatibility which exists between two wellbore fluids, such as drilling mud and cement, or drilling mud and completion fluid. They separate or prevent contact between the two fluids. The targeted density of the spacer is dependent upon well conditions, most specifically, the density of the drilling mud in the wellbore at the time of displacement. Typically, the density of the spacer is desired to be between from about 9 to about 20 ppg.

In another preferred embodiment, the well treatment fluid may form a fluid loss pill, which may then be pumped into the wellbore or formation. The fluid loss pill alleviates fluid loss from the wellbore or formation. When used as a fluid loss pill, it is preferred that the brine of the pill be compatible with the brine of the completion fluid in order to avoid salt precipitation. The brine in the fluid loss pill may or may not be the same as the completion fluid brine. The fluid loss pill should have a density equal to or greater than the density of the completion brine in order that the fluid loss pill may remain in contact with the formation wall at the desired depth in the wellbore and not be displaced by the completion brine. Typically, the amount of fluid loss pill added to the completion brine is dependent on hydrostatic pressure, formation pressure, volume of the hole adjacent to the perforation or fluid loss zone, formation permeability, pill viscosity at the bottom hole temperature and thermal degradation rate of the pill.

In another preferred embodiment, the nanoparticles are a component of a drill-in fluid. Such fluids deposit a low-permeable filter cake on the walls of the wellbore or formation and thereby seal the wellbore or formation. In so doing, the filter cake protects the wellbore or formation from fluid damage by shielding such fluids from permeating into the formation. When used as a drill-in fluid, the fluid typically contains brine having a density greater than 12 ppg.

The well treatment fluid may be prepared off-site and shipped to the desired subterranean formation to be treated. The presence of the nanoparticles in the well treatment fluid prevents settling during transportation.

The following examples will illustrate the practice of the present invention in preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow.

### EXAMPLES

### Example 1

The equivalent of one laboratory barrel (barrel equivalent, BEQ: 350 milliliters) of a drill-in fluid was prepared by combining 4.6 grams lime and 90 grams nano-particle calcium carbonate in 0.89 BEQ (313 milliliters) 14.2 ppg calcium bromide brine at room temperature at a designated pH. This sample was sheared at 5500 rpm for about 1 minute using a Silverson dispersator Model L4RT. The initial rheology value was taken between 80° F. and 85° F. The fluid was subsequently statically heat aged (HAs) at 350° F. for 16 hours. Viscosity measurements of the HAs samples were then taken at room temperature (˜72° F.). All viscosity values were measured using a Baroid Multi-Speed Rheometer from between 3 to 600 rpm. Plastic viscosity (PV), apparent viscosity (AV), yield point (YP), and gel strength were determined. The latter was determined as 10 sec/10 min readings at 3 rpm. Sag performance was measured by stratification testing wherein a sample of the fluid contained in a Teflon vessel was sealed within a stainless steel cell and placed vertically in an oven maintained at 350° F. The cell was pressurized using nitrogen to prevent loss of volatiles from the fluid. After the test period of 16 hours or other test duration, the cell was cooled to room temperature, depressurized and the volume of “top” (i.e., separated) brine was measured and expressed as a percentage of the total fluid volume. After the initial heat aged data was collected, the fluid was diluted with 8% by volume water, the properties measured and the sample was re-heat-aged for 16 hours at 350° F., after which the properties were again measured. The results are set forth in Table I below:

TABLE I

| | | | 8% | |
|---|---|---|---|---|
| | | | Water | |
| Test | Initial | HAs | Dilution | HAs |
| Fann: 600 rpm | 37 | 91 | 63 | 95 |
| Fann: 300 rpm | 22 | 65 | 45 | 74 |
| Fann: 200 rpm | 17 | 54 | 37 | 65 |
| Fann: 100 rpm | 10 | 42 | 28 | 54 |
| Fann: 6 rpm | 3 | 26 | 16 | 37 |
| Fann: 3 rpm | 3 | 22 | 16 | 34 |
| Gel, #/100 ft² | 4/6 | 25/25 | 17/17 | 32/36 |
| AV, cP | 19 | 46 | 32 | 48 |
| PV, cP | 15 | 26 | 18 | 21 |
| YP, #/100 ft² | 7 | 39 | 27 | 53 |
| pH | 8.4 | 8.6 | — | 8.6 |
| Sag, % | | <8 | | <8 |

### Example 2

The procedure of Example 1 was repeated except that 0.91 BEQ (320 milliliters) 14.2 ppg calcium bromide brine was combined with 4.7 grams lime, 66 grams nano-particle calcium carbonate and 2.6 grams surfactant (commercially available as MDR-1, a product of BJ Services Company) at room temperature at a designated pH. This fluid was sheared for about 1.5 minutes at 5500 rpm. The fluid was sequentially statically heat aged (HAs) at 350° F. for 22, 24 and 161 hours. The results are set forth in Table II below:

TABLE II

| | | HAs, | HAs, | HAs, |
|---|---|---|---|---|
| Test | Initial | 22 hr | 24 hr | 161 hr |
| Fann: 600 rpm | 59 | 70 | 70 | 63 |
| Fann: 300 rpm | 38 | 45 | 41 | 37 |
| Fann: 200 rpm | 30 | 33 | 30 | 26 |
| Fann: 100 rpm | 22 | 21 | 18 | 17 |
| Fann: 6 rpm | 9 | 6 | 6 | 7 |
| Fann: 3 rpm | 8 | 4 | 4 | 6 |
| Gel, #/100 ft² | 6/8 | 6/8 | 5/7 | 6/10 |
| AV, cP | 30 | 35 | 35 | 32 |
| PV, cP | 21 | 25 | 29 | 26 |
| YP, #/100 ft² | 17 | 20 | 12 | 11 |
| pH | 8.8 | 8.8 | 8.8 | 8.8 |
| Sag, % | | Trace | None | None |

### Example 3

The procedure of Example 2 was repeated except that a 0.89 BEQ (312 milliliters) 14.2 ppg 14.2 calcium bromide brine was combined with 0.16 grams lime and 90 grams nano-particles calcium carbonate at room temperature at a designated pH. This solution was sheared for about one minute at 5500 rpm. The fluid was sequentially statically heat aged (HAs) at 350° F. for 22, 24 and 161 hours. The results are set forth in Table III below:

TABLE III

| | | HAs, | HAs, | HAs, |
|---|---|---|---|---|
| Test | Initial | 22 hr | 24 hr | 161 hr |
| Fann: 600 rpm | 39 | 82 | 78 | 67 |
| Fann: 300 rpm | 25 | 56 | 52 | 42 |
| Fann: 200 rpm | 20 | 47 | 42 | 33 |
| Fann: 100 rpm | 13 | 35 | 30 | 22 |
| Fann: 6 rpm | 6 | 15 | 13 | 9 |
| Fann: 3 rpm | 4 | 15 | 10 | 7 |
| Gel, #/100 ft² | 6/6 | 15/17 | 11/13 | 8/11 |
| AV, cP | 20 | 41 | 39 | 34 |
| PV, cP | 14 | 26 | 26 | 25 |
| YP, #/100 ft² | 11 | 30 | 26 | 17 |
| pH | 6.3 | 7.2 | 7.1 | 6.4 |
| Sag, % | | ~4 | ~4 | ** |

** fluid striated top to bottom

Table I illustrates acceptable rheological data for 350° F. HA static using a composition containing a brine mixture of lime and the calcium carbonate. Table III illustrates better rheological data and improved HAs properties at 350° F. (over an extended period of time) when the lime is minimized and the composition adjusted to a starting pH of about 6. Each of the Tables illustrates that the drill-in fluid (containing a high density brine) retained its rheology at 350° F. Favorable HAs properties and essentially no sag is reported in Table II when the composition contains a surfactant.

From the foregoing, it will be observed that numerous variations and modifications may be effected without departing from the true spirit and scope of the novel concepts of the invention.

What is claimed is:

1. A well treatment fluid comprising water or brine and at least one additive having a median particle size of less than 1 micron, wherein the at least one additive is capable of viscosifying the water or brine in the substantial absence of a polymeric viscosifying agent.

2. The well treatment fluid of claim 1, wherein the fluid is stable at a temperature of 350° F.

3. The well treatment fluid of claim 2, wherein the fluid is stable at a temperature of 400° F.

4. The well treatment fluid of claim 1, wherein the fluid is free of a polymeric viscosifying agent.

5. The well treatment fluid of claim 1, wherein the mean particle size of the at least one additive is less than or equal to 0.5 micron.

6. The well treatment fluid of claim 5, wherein the mean particle size of the at least one additive is less than or equal to 0.1 micron.

7. The well treatment fluid of claim 1, wherein the density of the brine is greater than about 9 pounds per gallon.

8. The well treatment fluid of claim 7, wherein the density of the brine is greater than or equal to 13.0 pounds per gallon.

9. The well treatment fluid of claim 1, wherein the fluid is a drill-in fluid.

10. The well treatment fluid of claim 1, wherein the fluid is a thermal insulating fluid.

11. The well treatment fluid of claim 1, wherein the fluid is a spacer.

12. The well treatment fluid of claim 1, wherein the fluid controls fluid loss.

13. A well treatment fluid having nanoparticles self-suspended in a high density brine, wherein the nanoparticles are capable of being suspended in the brine in the substantial absence of a suspending agent and further wherein the median particle size of the nanoparticles is less than or equal to 1 micron.

14. The well treatment fluid of claim 13, wherein the mean particle size of the nanoparticles is less than or equal to 0.5 micron.

15. A water or brine-based well treatment fluid suspension comprising nanoparticles which are substantially self-suspended in the water or brine, wherein the median particle size of the nanoparticles is less than or equal to 1 micron and further wherein the water or brine-based well treatment fluid suspension exhibits greater thermal stability than a corresponding water or brine-based well treatment fluid suspension containing particles having a median particle size greater than or equal to 3 microns.

16. The well treatment fluid suspension of claim 15, wherein the suspension is substantially free of a polymeric viscosifying agent.

17. The well treatment fluid suspension of claim 15, wherein the density of the brine is greater than or equal to 13.0 pounds per gallon.

18. A method of treating a subterranean formation which comprises introducing into the formation or wellbore the well treatment fluid of claim 1.

19. A method of treating a subterranean formation which comprises introducing into the formation or wellbore the well treatment fluid of claim 13.

20. A method of treating a subterranean formation which comprises introducing into the formation or wellbore the well treatment fluid of claim 15.
